(19) United States
(12) Patent Application Publication
(10) Pub. No.: US 2003/0001015 A1
(43) Pub. Date: Jan. 2, 2003

(54) Voting device with immediate feedback

(76) Inventor: William Spence Rouverol, Berkeley, CA (US)

Correspondence Address: William S. Rouverol, 1331 Arch St., Berkeley, CA, 94708, US

(21) Appl. No.: 09/895,190

(22) Filed: Jul. 2, 2001

(51) Int. Cl. G06K 7/10

(52) U.S. Cl. 235/458; 235/489

(57) ABSTRACT

All data registering devices, including voting machines, are subject to error, either from human lapses or mechanical malfunction. The object of the present invention is to disclose a device that incorporates features that immediately alert the user to the fact that an error has occurred, before it is too late or too inconvenient for the user to correct it. In voting devices that produce a machine-processable record card, such as the Votomatic and the Poll Star, votes are counted photo-electrically by shining a light through holes punched in the ballot card. According to the present invention, the greatest certainty regarding what punch-outs represent a valid vote can be obtained only if the same principle is employed to inform the voter as to whether his punch-out is or is not in the intended position and is a complete punch-out. To provide the voter with this verification, backlighting is introduced that directs a beam of light upward through each punch-out toward the voter's eye. To achieve the optimum results, which demand that the frequency of faulty ballots be less than about one percent the special backlighting features employed are combined with mechanical improvements that minimize defective punch-outs.

### BACKGROUND OF THE INVENTION

1. Field of the Invention

This invention relates to devices for the manual registering of data on machine-processable record cards. More particularly it relates to punch-card voting devices.

2. Prior Art

The principal prior art resides in the basic patents concerning the “Votomatic” voting device, relative to which the invention discloses improvements intended to increase the accuracy of that voting system. The basic patents on the Votomatic are U.S. Pat. Nos. 3,201,038 and 3,240,409. A U.S. patent referred to in the latter is No. 3,007,620.

### SUMMARY OF THE INVENTION

All data registering devices, including voting machines, are subject to error, either from human lapses or mechanical malfunction. The object of the present invention is to disclose a device that incorporates features that immediately alert the user to the fact that an error has occurred, before it is too late or too inconvenient for the user to correct it. In voting devices that operate on a machine-processable record card, such as the Votomatic and the Poll Star, votes are counted photo-electrically by shining a light through holes punched in the ballot card. According to the present invention, the greatest certainty regarding what punch-outs represent a valid vote can be obtained only if the same principle is employed to inform the voter as to whether his punch-out is or is not in the intended position and is a complete punch-out. To provide the voter with this verification, backlighting is introduced that directs a beam of light upward through each punch-out toward the voter's eye. To achieve the optimum results, which demand that the frequency of faulty ballots be less than about one percent, the special backlighting features employed are combined with mechanical improvements that minimize defective punch-outs.

Backlighting had previously been considered and rejected because it was in conflict with the disposal of the chads. As more and more chads were accumulated underneath the punching surface, they would blanket the light source, reducing or eventually eliminating the illumination and possibly even creating a fire hazard if the light was hot enough. The solution to this problem, which is a main feature of the invention, was to divide the illumination into two parts, one well to the right of the region where the punched out chads fall vertically by gravity, and one well to the left of the region. The two light sources are directed to throw their light at opposite angles toward the underside of the punch card, and this combined effect is a bright vertical beam that tells the voter he/she has (or has not) made a clear punch-out directly adjacent to the right (or wrong) candidate's name. Obtaining this feedback information enables the voter to make immediate correction on his/her original ballot or, for more serious errors, to obtain a fresh ballot card from the precinct attendant. Every form of errant card punch can be quickly identified with this punch-out backlighting. The only person who can make this correction without a breach of ballot secrecy is the voter, and he/she has full opportunity to make the necessary repair, regardless of whether it is a “dimpled” chad, a hanging chad, undervoting, overvoting, or a misplaced vote. Even the notorious “butterfly ballot” which has been shown to confuse and disqualify thousands of voters would not be a problem.

When the above-described voter-activated backlighting system for the exposure and correction of ballot errors is combined with some very advantageous improvements in mechanical features, punch-card voting should become more reliable and accurate than any electronic voting system currently available, including optical scanning and touch-screen, as well as costing only a fraction as much to install and operate. Hopefully the improvements disclosed will reduce the observed undervoting or defective voting on punch-card voting devices from its present 1 to 4% to perhaps as low as ⅓ to 1/4%. This level of accuracy is better than that of any competing device and should make a manual recount seldom if ever needed. It is not conceivable that the improvement described herein can achieve what should be the goal of all voting machines: zero disenfranchisement.

### BRIEF DESCRIPTION OF THE DRAWINGS

FIG. 1 is a sectional view of a voting device embodying the invention. It is analogous to FIG. 2 of U.S. Pat. No. 3,240,409, which shows in FIG. 1 the position and direction of sight of the sectional cut. The view indicates how a Votomatic could be modified to provide backlighting that illuminates the underside of the punch card.

FIG. 2 is a broken-out plan view indicating one method of introducing a limit switch that energizes the lighting circuit when the punch card is properly inserted.

FIG. 3 is a wiring diagram for the embodiment that uses a single electric light bulb.

FIG. 4 is a wiring diagram for the embodiment that specifies two electrical light bulbs in parallel.

FIG. 5 is an enlarged diagram showing how the stylus may bind up in the inner template hole.

FIG. 6 is an enlarged diagram showing a modification to the stylus probe that prevents it from binding in the inner template apertures.

FIG. 7 shows a voter instruction sheet adapted to reduce the frequency of voter errors that lead to overvotes, undervotes, or incomplete chad removal.

### DESCRIPTION OF THE PREFERRED EMBODIMENTS

Because the invention consists of a set of improvements to the punch-card devices covered by the above-listed prior art patents, the descriptions below will concentrate insofar as possible on the new features introduced, showing only as much of the prior art structures as is needed to support the applicant's claims. A full explanation of how the Votomatic voting device operates is provided in U.S. Pat. No. 3,240,409, so it will not be reiterated in this specification. The fact that assigned part numbers are the same as those assigned in that patent should not be construed to imply that the disclosed improvements are applicable only to the Votomatic. They are equally applicable to most other punch-card voting devices as well.

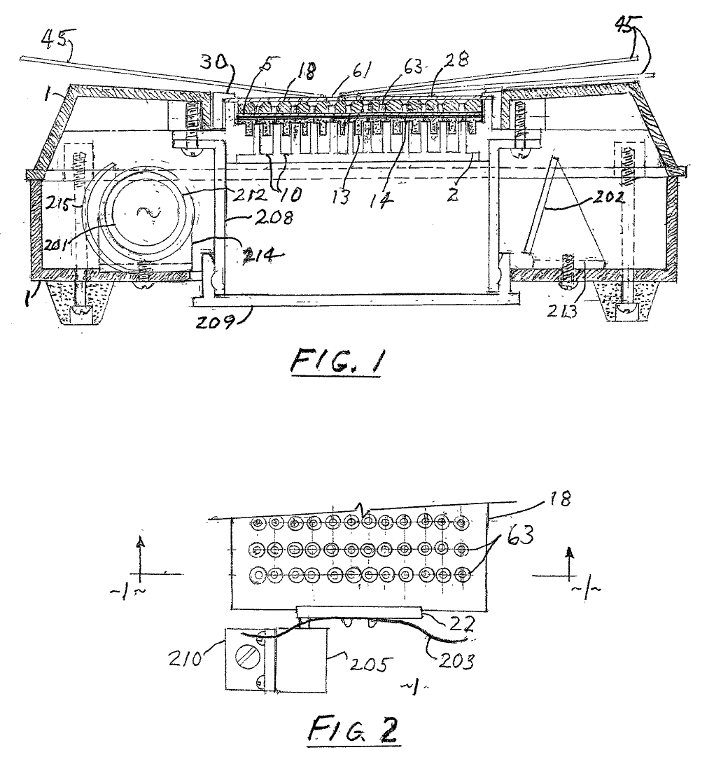

In detail and referring to the drawings, FIG. 1 is analogous to FIG. 2 in U.S. Pat. No. 3,240,409. Comparing the two figures, it will be seen that the housing 1 has been made much deeper. This is to provide space for at least one electric lamp but preferably two light sources, consisting of an elongated light bulb 201 to the left of the punching die strips 13, and a mirror 202 to the right of those strips. Mirror 202 and the socket 212 for bulb 201 are supported on brackets 213 and 214 fixed to the bottom part of housing 1. Bulb 201 shows here as a circle, since it is a sectional view. A plan view of it would show that its diameter is at most a third of its length, and preferably a fifth or less. The lengthwise dimension of bulb 201, which ideally is similar to the length of the columns of preperforated areas of the punch card, is oriented parallel to the long direction of the base 2, and the same is true of mirror 202. A cylindrical or parabolic reflector 215 may be used to direct the light from bulb 201 toward the mirror 202 and the underside of die strips 13.

Both bulb 201 and mirror 202 are mounted below the plane occupied by punch card 5 when that card has been inserted into the device. Mirror 202 is tilted at an angle and has a width such that beams of light from bulb 201 are reflected directly from the lower edge of mirror 202 to the left-most die strip 13, and from the upper edge of mirror 202 to the right-most die strip 13. This arrangement ensures that the left side of all the T-strips is illuminated by bulb 201 and the right side by mirror 202, so that when any aperture is made in punch card 5, the combined illumination will send a strong beam of light upward to the eye of the voter. (For “right” read “left” and vice versa if bulb 201 is to the right and mirror 202 to the left of die strips 13.)

Several other characteristics of FIG. 1 should be noted. The T-strips have the same shape as the corresponding T-strips 13 in U.S. Pat. No. 3,240,409, but they are made of a different material. Instead of the opaque black rubber T-strips 13 used in the Votomatic and other prior art punch card devices, the T-strips 13 shown in FIG. 1 are made of a resilient elastomer that is pervious to light (transparent or translucent), such as latex or clear urethane rubber. In addition, the supporting ribs 10 and the lower part of frame 30, which in the Votomatic are molded of opaque plastic, are in the present invention molded of a transparent plastic such as clear acrylic (“Lucite”) or clear polystyrene. The combination of the pervious-to-light T-strips 13 and the transparent supporting ribs 10, which are an integral part of base 2, ensures that the maximum amount of light will reach the underside of the punch card 5. This gives to the voter “instant verification” that he/she has produced a clear punch-out.

It will be evident, from comparing the structure disclosed in FIG. 1 to that of FIG. 2 of the Votomatic patent, that the depth of the sides of base 2 has been increased by introducing a transparent protective sleeve 208. This is to ensure that the light sources (bulb 201 and mirror 202) are protected from the chads 62 that have been punched out of card 5. Sleeve 208 is rectangular in a plan view and has a projected area that is the same as card 5. Its bottom end opens into a removable plastic collection box 209 that catches the falling chad 62.

In general, all of the desirable features of the Votomatic may be retained in voting devices having the improvements disclosed in this specification. This includes (a) making the housing in two parts, a top part and a bottom part, as show in FIG. 1 and FIG. 2 of U.S. Pat. No. 3,240,409 and (b) utilizing two templates, an outer template 28 having apertures 61 only at positions adjacent to ballot choices printed on the spaced-apart leaves 45, and an inner template 18 having apertures 63 only at positions that are in register with preperforated areas 62 on ballot card 5 when it is inserted into the device far enough to bear against a flange 22 cemented to the lower end of said inner template 18 (see FIG. 9 of U.S. Pat. No. 3,240,409). As explained in the specification of said patent, when said ballot card 5 is fully inserted, said inner template 18 is shifted to a position of register of the apertures 63, 61 of said inner and outer templates 18, 28 respectively, against the urging of a light spring 25 bearing against said flange 22 (per said FIG. 9).

Although the Votomatic is the best of all prior art punch-card voting devices, it shares with these prior art devices one important shortcoming that is responsible for about half the 1% or so of defective ballots commonly cast on that machine. A failure of the voter to insert the ballot card 5 far enough into the device to bring the template apertures 61, 63 into register causes the punching stylus 64 to strike the inner template 18 between adjacent apertures 63 so that it is prevented from reaching the ballot card 5. To remedy this particular shortcoming, the present invention proposes to put the switch that turns on the backlighting at a position such that the energizing of light sources 201 and 202 occurs only if the inner template 18 is at the point where apertures 61 and 63 are both in register with preperforated areas 62, that is to say, when the ballot card 5 is fully inserted. Since the voter is instructed not to vote until the backlighting is on, this serves as a dramatic reminder that the ballot card must be fully inserted.

One way to switch on the backlighting is shown in FIG. 2. This is a partial plan view of the bottom end of the inner template 18, made visible by a break-out of part of frame 30. Flange 22 projects downward from the lower end of the inner template 18 and carries a light metal leaf spring 203 in place of the coil spring 25 shown in FIG. 9 of U.S. Pat. No. 3,240,409. At or adjacent to the central portion of leaf spring 203 or any convenient point on flange 22 or the bottom edge of the inner template 18, there is a limit switch 205 that is positioned to close at the exact point when the preperforated areas 62 of card 5 and apertures 61 and 68 are all in register. Limit switch 205 is mounted on an L-shaped bracket 210 that is in turn mounted on the lower portion of housing 1. One lead of limit switch 205 is connected to bulb 201 and the other to the main power supply, as shown in FIGS. 3 and 4.

It will be seen from FIG. 3 that the power circuit for bulb 201 is a very simple one, consisting only of the bulb itself and limit switch 205 in series. The bottom part of housing 1 may be either metal or plastic, but if it is metal it should be connected to the ground wire of the power supply cord. Although it is possible to use a second bulb in parallel with bulb 201 (FIG. 4), this is less desirable than using one bulb and a mirror 202, as shown in FIG. 1, on the basis of first cost, heat generation, and amperage load imposed on limit switch 205. Mirror 202 may of course be omitted, but this would cause the right hand columns of punch-outs to have less illumination than the left-hand columns.

FIG. 5 is a schematic drawing that illustrates the second main shortcoming of the Votomatic, which is just as serious as failing to insert the ballot card 5 fully. In FIG. 5, it will be seen that the stylus 64 is not held vertical to the face of the inner template 18, so that the stylus probe 65 is subject to what may be called “the dresser drawer effect.” Because the apertures 63 in the inner template 18 are partly cylindrical, the sharp edge of the probe 65 can dig into the side wall of the aperture 63, and bind the stylus 64 against further inward movement. If there is substantial tipping of the stylus 64, the digging in will occur high up in aperture 63 so no mark will be made on the ballot card 5, and no vote will have been cast. If the stylus 64 tipping is less extreme, the digging in will occur much close to the bottom of the aperture 63, so that only the needle-like tip 71 of the stylus 66 will reach the card 5, to make a “dimple” on the preperforated area 62 but no dislodgement of this area will occur, and the mechanical card-reader will not record a vote. This opens the door to controversies as to what should count as a vote and what should not.

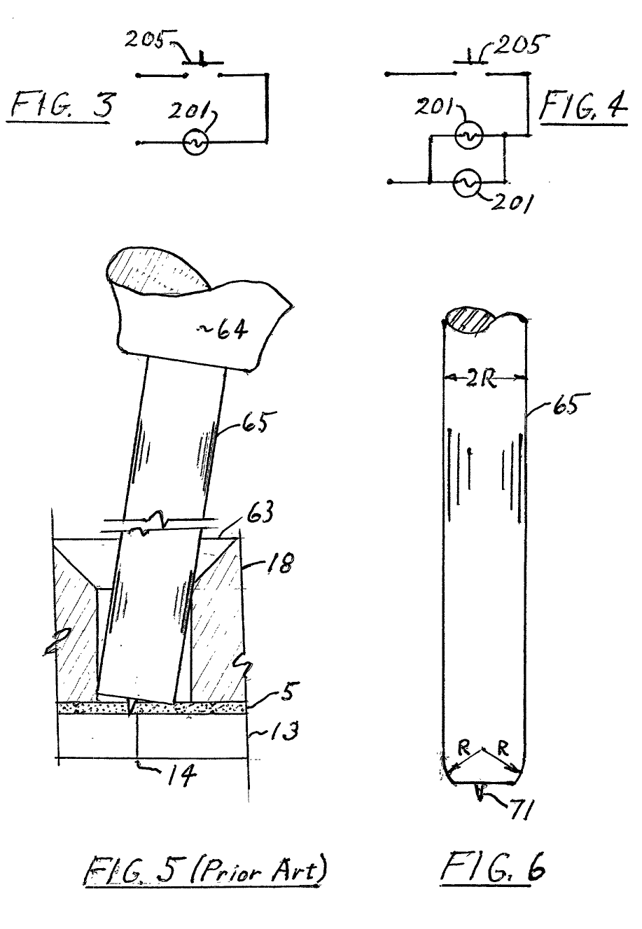

To reduce the frequency of such problems, a small change may be made to the stylus probe 65, as indicated in FIG. 6. The sharp corner of the stylus probe 65 is rounded sufficiently to prevent the “dresser drawer” effect. The particular amount of rounding depends on the clearance provided between the diameter of the cylindrical portion of the aperture 63 in template 18 and the diameter of the stylus probe 65. It is also important that the rounded portions have as smooth a finish as the balance of probe 65, so that both can be completely free of machining ridges or grooves.

As shown in FIG. 5 the Votomatic stylus 64 has a needle-like tip 71 protruding from the end of the probe 65. The function of this small protrusion is to spear the preperforated area 62 of card 5 so that it cannot slide laterally during the punching action and hang up on one end or one side, producing what is called a “hanging chad” instead of a clean punch-out. There is not much question that a hanging chad counts as a vote in a manual recount, but if such a chad happens to get folded back to reoccupy its original aperture in the main body of card 5, no light may be transmitted through the punch-out so no vote will be recorded. For this reason it is desirable to strip away any hanging chads present on the completed ballot. This can and should be done by the voter, with or without the aid of the backlighting. It is important to note that a stylus 64 on which the needle-like tip 71 has been broken or worn off will produce many more hanging chads than one on which the spear-like tip 71 is intact.

FIG. 7 shows an instruction sheet 207 that should be continuously visible to the voter. Ideally it should be mounted just above the voting device. This is decidedly preferable to having it printed on one side of the first or second ballot leaf 45.

In summary, it should be noted that the foregoing disclosures all have the same objective, namely the reduction of ballot errors currently being produced by the best presently available voting device, the Votomatic, from its average error rate of about 1% to 0.5% or less, A realistic goal may be as small as 0.2 or 0.3%. The shortcomings of the Votomatic (sensitivity to insufficient insertion of the ballot card 5 and tilting of the stylus 64) have both been addressed herein by three innovations, and it is the hope of the applicant that this “fail-safe” approach will achieve the desired results, of largely eliminating voting errors.

Both the above-noted shortcomings are addressed by (1) more visible instructions (FIG. 7), and (2), the disclosed system of backlighting, which affords the voter a unique “instant verification” of a clean punch-out. The third innovation is different for each of the two above-noted shortcomings. Insufficient card insertion is addressed by having the backlighting turned on by full insertion of the ballot card 5, and excessive tilting of the stylus 64 is offset by rounding the sharp corner of the stylus probe 65.

The following observations are believed to be relevant to the claims: (a) All punch-card voting devices are designed for a particular ballot card 5, because the horizontal spacing of the parallel columns of perforated areas 62 must be the same for apertures 61 and 63, adjacent leaf 45 axes, and adjacent die T-strip 13 slits 14 and ribs 10; similarly, the vertical spacing of the parallel rows of the preperforated areas 62 must match the vertical spacing of apertures 61 and 63 and choices exhibited on the ballot leaves 45. Most punch card voting devices are designed for the same generally available ballot card 5, which has 12 columns and 26 rows of preperforated areas 62. Accordingly, the card 5 is not part of the claimed structure. (b) Preferred lamps include a long and narrow incandescent bulb (type T10) or an even longer and narrower fluorescent bulb (e.g., F9BX). The latter runs cooler and imposes only a fourth as much amperage on the limit switch 205. LEDs can also be used. (c) The description “pervious to light” includes both transparent and translucent. (d) If it is desired to reduce the number of hanging chads, the preperforated areas 62 may be made circular, in which case the slits in the punching die should be two directional, as for example a + shape. (e) In keeping with industry usage, a preperforated area 62 is called a “chad” once it is fully or partially detached from the body of the ballot card 5. (f) For the purposes of the claims, a stylus is a light form of punch, appropriate for a punch-out that has been preperforated. (g) Any light source used should be offset from the region beneath the die, so that no chads will blanket it. (h) The term “lamp” or “electric light bulb” includes all types of bulb, whether incandescent, fluorescent, LED, or any other form of electrically-driven illumination. (i) Instead of the enclosed limit switch 205 shown in FIG. 2, two contacts on leaf spring 203 may be used. (j) The preferred feature for holding the ballot card 5 in place is the same one used by the Votomatic, which is a pair of red colored pins. (k) It will be obvious that if a spacer is inserted into the housing 1 of a Votomatic, it can be made deep enough to accommodate one or more light sources. (l) Although the device disclosed herein is called a “voting device”, it may also be sued for exams, surveys, etc. (m) If desired, a blinker may be introduced into the lighting circuit. (n) The removable catch basket 209 provided to catch the falling chads should be either transparent or low enough not to interfere with light beams emitted by bulb 201 and directed toward the T-strips or mirror 202. (o) Mechanical devices could be introduced to overcome the shortcomings of the Votomatic, but they would increase the cost of the disclosed device and increase its complexity. The latter is always a problem because complexity tends to produce errors. Examples of such mechanical means include a door that is closed to force a complete insertion of the ballot card 5 as shown in FIG. 11 of U.S. Pat. No. 3,240,409. Another such device that could be introduced to keep the stylus 64 perpendicular to the ballot card would be a square-section telescoping arm pivotally mounted at one corner of the housing 1 and holding at its free end a vertically slidable stylus. It appears likely that the complexity of such arrangements would produce more errors than will occur with the above-described tip-rounded stylus fastened to a bead chain. (p) Another mechanical device that could be introduced is a sharpened sheet steel scraper mounted on the bottom of the ballot slot 4. The purpose of this would be to scrape off the back side of the ballot any hanging chad as the ballot is withdrawn from its slot. While it is desirable to get rid of all hanging chads, this is not the way to do it, as it deviates from the basic concept of the present invention, which is to alert the voter to any improper punch-out so he/she can take steps to make the necessary repair. Since the scraper would operate on the ballot after the voter has finished, the “instant verification” would be circumvented and any unexpected error produced by the scraper would go uncorrected. It is much better to have “hanging chads,” on the rare occasions when they do occur, discovered and corrected by the voter, as proposed in the FIG. 7 instruction section “When you finish voting.” (q) The term “light source” means an electric lamp or at least one mirror or other reflective surface. (r) If a sole lamp or light bulb is positioned above the plane of the card (5), there must be at least one mirror or other image-reflecting surface below that plane. (s) If bulb 201 is an incandescent light, apertures should be provided in the top and bottom of housing 1 to increase the convection of air for cooling. (t) On the same side of housing 1 that houses lamp 201, a “ready-to-vote” signal light (preferably green) is mounted, to tell the voter that the backlighting is operative. This signal light is illuminated by diverting a small portion of the light produced by bulb 201 by a small mirror.

1. A punch-card device including a punch, a die adapted to support a machine-processable record card while it is being punched, and a light source mounted below the plane of said card in a position to direct light through the aperture made in said card by said punch.

2. A punch-card device according to claim 1 wherein said light source includes an electric light bulb and a mirror.

3. A punch-card device according to claim 1 wherein said light source includes two electric light bulbs.

4. A punch-card device according to claim 1 wherein said light source includes an electric light bulb, partially surrounded by a reflector.

5. A punch-card device according to claim 1 wherein said light source includes an electric light bulb having an overall length greater than three times its maximum diameter.

6. A punch-card device according to claim 1 wherein said light source is illuminated by the operation of a limit switch closed by the full insertion of said card into said device.

7. A punch-card device according to claim 1 wherein the upper surface of said die is made of a material that is pervious to light.

8. A punch-card device according to claim 1 wherein the upper surface of said die is supported on ribs made of transparent material.

9. A punch-card device according to claim 1 wherein at least one transparent pane is interposed between said light source and chads punched out of said card.

10. A punch-card device according to claim 1 wherein light from said light source is made visible to the user of said device, to indicate to said user that the light source is energized.

11. A punch-card device according to claim 1 wherein an open space is provided below said die, said space having at least as great a width and length as said die, and a depth at least as great as the vertical height of said light source.

12. A punch-card device according to claim 1 wherein said punch is in the form of a stylus with (a) a handle and (b) a slender probe, preferably of metal and having a diameter smaller than the minimum width of preperforated areas to be punched out of said card, the free end of said probe being slightly rounded to prevent binding during the punch operation.

13. A punch-card device according to claim 1 wherein said light source includes one electric light bulb and one mirror spaced apart by more than the width of said die.

14. A punch-card device according to claim 1 wherein instructions to the user regarding the proper method for inserting said card and manipulating the punch are visible to said user during the punching operation.

15. A punch-card device according to claim 1 wherein said card has a plurality of preperforated areas.

16. A punch-card device according to claim 1 wherein said card has a plurality of preperforated areas arranged in a plurality of rows and a plurality of columns.

17. A punch-card device according to claim 1 wherein said card has a plurality of preperforated areas arranged in a plurality of rows and a plurality of columns, and said device has a plurality of leaves turnably mounted on co-planar parallel axes spaced apart by multiples of the distance between adjacent columns of said preperforated areas.

18. A punch-card device according to claim 1 wherein said card has a plurality of preperforated areas arranged in a plurality of rows and a plurality of columns, and said device has a plurality of leaves turnably mounted on co-planar parallel axes spaced apart by multiples of the distance between adjacent columns of said preperforated areas, said leaves each having an edge adjacent to a different column of said preperforated areas and exhibiting a plurality of legible choices each aligned with a different one of said rows.

19. A punch-card device according to claim 1 wherein said card has a plurality of preperforated areas arranged in a plurality of rows and a plurality of columns, and said device has a plurality of leaves turnably mounted on co-planar parallel axes spaced apart by multiples of the distance between adjacent columns of said preperforated areas, said leaves each having an edge adjacent to a different column of said preperforated areas and exhibiting a plurality of legible choices each aligned with a different one of said rows, said device also having (a) an opaque outer template mounted immediately underneath the plane of said axes and having an aperture adjacent to each of said choices, and (b) a transparent inner template immediately underneath said outer template and having an aperture in register with each preperforated area of said card when said card has been inserted into said device sufficiently to bear against a flange fixed to the lower end of said inner template.

20. A punch-card device according to claim 1 wherein said card has a plurality of preperforated areas arranged in a plurality of rows and a plurality of columns, and said device has a plurality of leaves turnably mounted on co-planar parallel axes spaced apart by multiples of the distance between adjacent columns of said preperforated areas, said leaves each having an edge adjacent to a different column of said preperforated areas and exhibiting a plurality of legible choices each aligned with a different one of said rows, said device also having (a) an opaque outer template mounted immediately underneath the plane of said axes and having an aperture adjacent to each of said choices, and (b) a transparent inner template immediately underneath said outer template and having an aperture in register with each preperforated area of said card when said card has been inserted into said device sufficiently to bear against a flange fixed to the lower end of said inner template, said card shifting said inner template to a position of register of the apertures in said inner and said outer templates against the urging of a light spring bearing against said flange.

21. A punch-card device according to claim 1 wherein the upper surface of said die is made of a resilient material and has slits adapted to permit said punch to detach preperforated areas from said card and force t hem into the open space beneath said die.

22. A punch-card device according to claim 1 wherein said punch is in the form of a stylus with (a) a handle and (b) a slender probe, preferably of metal and have a diameter smaller than the minimum width of preperforated areas to be punched out of said card, the free end of said probe being slightly rounded to prevent binding during the punching operation and having a needle-like projection adapted to spear said preperforated areas of said card.

23. A punch-card device according to claim 1 wherein a rectangular open-top box is snapped onto the underside of said device beneath said die, adapted to catch all chads punched out of said card.

24. A punch-card device according to claim 1 wherein a small portion of the illumination from said light source is made visible to the user of said device, to signal that said device is ready for voting.
